(19) United States
(12) Patent Application Publication
(10) Pub. No.: US 2025/0334189 A1
(43) Pub. Date: Oct. 30, 2025

(54) BALL VALVE AND ITS USE

(71) Applicant: Hanon Systems, Daejeon (KR)

(72) Inventors: Carsten Ohrem, Bergheim (DE); Dominik Wiechard, Köln (DE); Maximilian Wesselmann, Odenthal (DE); Matthias Binz, Brühl (DE)

(21) Appl. No.: 19/188,786

(22) Filed: Apr. 24, 2025

(30) Foreign Application Priority Data
Apr. 24, 2024 (DE) 10202411156.8
Feb. 20, 2025 (DE) 102025106496.2

(51) Int. Cl. F16K 5/06; F25B 41/20

(52) U.S. Cl. CPC F16K 5/0647; F25B 41/20

(57) ABSTRACT

A ball valve having a housing with at least one fluid passage which connects at least one inlet to at least one outlet, a valve ball, which has a through-hole, arranged between valve ball sealing seat elements in the fluid passage, a valve stem which is coupled to the valve ball for transmitting torque, which, supported by a sliding sleeve, is received in a housing opening and is sealed with a sealing ring on the valve stem circumference, and a mechanical rotation stop which is formed to limit a rotational movement of the valve stem in the interior of the housing.

### CROSS REFERENCE TO RELATED PATENT APPLICATIONS

This patent application claims the benefit of and priority to German Patent Application No. DE 10 2025 106 496.2, filed on Feb. 20, 2025, and German Patent Application No. DE 10 2024 111 456.8 filed Apr. 24, 2024, the entire contents of each of which are incorporated herein by reference for all purposes.

### TECHNICAL FIELD

The invention relates to a ball valve and its use in a refrigerant circuit of an air-conditioning system.

### BACKGROUND ART

In refrigerant circuits of air-conditioning systems, ball valves are the most important valve technology for the regulation and relaxation of a refrigerant. They are used, among others, in R134a and R1234Y F refrigeration systems as well as in systems with the R290 refrigerant. An important task is a targeted shut-off of refrigerant-carrying lines. This allows sections of the refrigerant circuit to be isolated without the entire refrigerant having to be drained. This not only makes work easier, but also minimises the loss of refrigerant, which brings economic and environmental advantages. Furthermore, a ball valve in the refrigerant circuit of an air-conditioning system can take over the function of an expansion member in order to lower the pressure of a refrigerant before it enters an evaporator. Since there are high pressures in refrigerant-carrying systems, ball valves are characterised by robust housings. A housing of a ball valve usually has two or more ports for refrigerant lines, wherein a rotatable valve ball with a through-hole is arranged in the interior of the housing. The valve ball is located between sealing seats and is coupled to an actuator via a valve stem. If the valve ball is rotated by means of the actuator, it can be oriented in the direction of a refrigerant line so that the refrigerant flows through the through-hole. By further rotation, the valve ball can be oriented transversely to the refrigerant line, as a result of which a refrigerant flow is blocked by the interaction of the valve ball and the sealing seats.

In order to fulfil technical tasks, the current technical implementation of ball valves requires a large number of complex individual parts. For example, a separate stop disc is provided for the necessary rotation limitation of the valve stem in known solutions. In this solution, the stop disc has on its circumference a notched region which interacts with stops positioned outside the housing such that a rotation region of the valve ball is fixed to predetermined rotation end points. The rotation end points can be formed as stop elements through mechanical barriers, such as, for example, inserted or screwed-in cylinder pins. Since the stop disc and the stop elements are present as separate components, additional assembly steps are required for their fastening, which is associated with increased assembly effort. A further disadvantage is that the mechanism of stop disc and stop elements on the housing outside occupies a comparatively large installation space, which limits the freedom of design on the housing outside and in certain cases requires an overall larger dimensioning of the ball valve. A further aspect which can be improved is the mounting of the bearing assembly for mounting the valve stem. In known solutions, the bearing assembly has a screw-on flange which must be fastened to the housing outside by means of screws. Usually, two or more screws are used to fasten the bearing assembly, which correspondingly increases the number of individual parts and the number of individual assembly steps. A higher number of complex individual parts generally leads to higher costs, higher assembly effort and higher susceptibility to faults. Furthermore, the increased complexity is associated with problems with respect to the manufacturing tolerances and the control accuracy.

### SUMMARY

It is therefore an object of the invention to propose a ball valve with which the known disadvantages can be overcome. A corresponding ball valve should have a lower complexity, be easier to assemble and require fewer individual parts. The ball valve should in particular be employable in a refrigerant circuit of an air-conditioning system.

The object is achieved by a ball valve with the features shown and described herein.

A ball valve according to the invention comprises a housing with at least one fluid passage which connects at least one inlet to at least one outlet. In the fluid passage of the housing, a valve ball is arranged enclosed from two sides between valve ball sealing seat elements. The valve ball has a through-hole which, when the valve ball is appropriately positioned, permits a flow through the fluid passage. Furthermore, the ball valve comprises a valve stem coupled to the valve ball for transmitting torque, which is received in a housing opening of the housing supported by a sliding sleeve and is sealed with a sealing ring on the valve stem circumference. According to the invention, the ball valve has a mechanical rotation stop, which is formed to limit a rotational movement of the valve stem in the interior of the housing.

The mechanical rotation stop has a stop geometry which can be located in the housing opening. According to a particularly simple design, the stop geometry can cooperate with at least one lug formed on the circumference of the valve stem such that a stop of the at least one lug on the stop geometry limits a rotational movement of the valve stem.

The stop geometry can be formed by recesses or cut-outs in the housing opening.

The at least one lug is formed as a radial shaping on the circumference in a region of the valve stem which is located in the housing of the ball valve. Consequently, the mechanical rotation stop formed from the stop geometry and the at least one lug on the valve stem is located in the interior of the housing, so that no additional installation space is required on the outside of the housing for the function of the mechanical rotation stop. It is furthermore advantageous that the at least one lug is formed as a shaping of the valve stem. Thus, no elements to be separately mounted are required, which facilitates assembly and reduces costs. Preferably, the valve stem is an injection-moulded part so that the valve stem can be produced in a simple manner at low cost in large numbers.

The housing opening accommodating the sliding sleeve and the valve stem is preferably formed as a stepped bore. The stepped bore has at least one shoulder with an axial end face which serves as a support for the sliding sleeve and/or the valve stem.

According to an advantageous design, the stop geometry can be formed on a shoulder of the housing opening in the form of two separate annular cut-outs, wherein one end of the valve stem facing the valve ball is formed as an axially offset flat pin with two lugs radially opposite one another on a shoulder which are each in engagement with one of the separate annular cut-outs. In this design, the radially opposite lugs are formed by the offset flat pin. The flat pin shoulder is thus in engagement on both sides with one respective annular cut-out. The rotational movement range is limited by the length in the circumferential direction of the annular cut-outs. The end of the valve stem facing the valve ball can be referred to as the lower flat pin.

The end of the valve stem, which is formed as a lower flat pin, can be used for torque transmission, wherein the flat pin end engages in a notch formed on the valve ball. Thus, a notch or a recess is located on the valve ball, into which the flat end of the valve stem is inserted in a form-fitting manner for force transmission.

Also at the opposite end, which faces away from the valve ball, the valve stem can have an upper flat pin in order to permit coupling with a drive element of an actuator. Thus, the valve stem can have an axially offset flat pin at both axial ends.

The upper flat pin cooperates with an actuator coupling element for coupling to a drive element of an actuator, wherein the actuator coupling element has an opening in the form of a rectangular recess so that the actuator coupling element can be plugged onto the upper flat pin of the valve stem.

According to one design, the upper flat pin can have an axial shoulder with an undercut on which the actuator coupling element engages on the upper flat pin. The actuator coupling element can have corresponding latching lugs which engage in the undercut. The latching ensures an easily detachable connection and a secure seating of the actuator coupling element on the valve stem.

According to an advantageous design, the valve stem is such that the upper flat pin and the lower flat pin are formed at axially opposite ends of the valve stem, wherein the upper flat pin and the lower flat pin each have a rectangular cross-section. According to the invention, this design is to be understood such that the upper flat pin and the lower flat pin have a longitudinal side and a broad side on their circumferences, wherein a length of the longitudinal side is several times greater than a length of the broad side.

According to an advantageous design, the housing opening has a collar on the outside of the housing, which is bent over towards the inside of the housing opening in order to fasten the sliding sleeve in the housing opening. A fastening of the sliding sleeve in the housing opening is thus ensured by crimping the collar formed on the housing opening. In this design, no additional separate fastening elements are required for fastening the sliding sleeve, as a result of which the assembly process is simplified and individual part costs can be saved. During crimping, the collar is deformed inwardly at the housing opening towards the opening centre, wherein the sliding sleeve supporting the valve stem is fixed and fastened in the housing opening. As a result of the crimping, the sliding sleeve does not require a separate flange so that the housing offers greater structural clearance on the housing outside.

The sliding sleeve is preferably formed from aluminium.

The sealing ring arranged on the circumference of the valve stem seals the region between the valve stem and the sliding sleeve in order to prevent the escape of refrigerant from the valve interior into the environment. In order to receive the sealing ring, the valve stem can have a circumferentially formed groove. In the assembled state, the sealing ring is arranged in the circumferentially formed groove for sealing with respect to the sliding sleeve. Since the circumferential groove is formed in the region of the valve stem which is spatially located in the housing interior, the sealing ring is thus likewise located in its arrangement within the housing of the ball valve.

According to an advantageous design, the sealing ring is characterised by an X-shaped cross-section.

According to an advantageous further development, the valve stem can have a valve stem shoulder formed on the circumference, wherein the sliding sleeve is formed as a wrap element which receives the valve stem shoulder formed on the valve stem in itself, so that the shoulder bears against an axial inner surface of the sliding sleeve. Since the sliding sleeve as a wrap element accommodates a valve stem shoulder formed on the circumference of the valve stem, axial mounting of the valve stem is ensured. Thus, the sliding sleeve serves for axial and radial mounting of the valve stem.

A further measure for reducing the complexity of the ball valve consists in simplifying the fastening of the ball sealing seat elements in the fluid passage in the interior of the housing. Usually, the ball sealing seat elements are held and fixed in the passage by a screwed-in ring or a screw ring or a screw, wherein a contact pressure is exerted with the screw ring or the screw on the valve ball held between the ball sealing seat elements. For this purpose, in the known solutions, a portion of the passage must have an internal thread, which represents an increased effort in terms of production technology. According to the invention, the valve ball sealing seat elements can be fixed in the passage, encompassing the valve ball, with a self-locking ring, a snap ring or a press-plug ring. For this purpose, only a groove or a shoulder, which is formed on the inner circumference of the fluid passage, is required in order to lock the securing elements against independent detachment.

The ball valve is applicable in a refrigerant circuit of an air-conditioning system. Specifically, the ball valve according to the invention is an expansion valve which is used in a refrigerant circuit. In particular, the ball valve is intended for use in an air-conditioning system which uses the refrigerant R134a, R1234Y F or R290.

### DESCRIPTION OF DRAWINGS

Further details, features and advantages of designs of the invention will become apparent from the following description of exemplary embodiments with reference to the accompanying drawings. Wherein:

FIG. 1: shows a schematic sectional representation of an example of a ball valve according to the state of the art,

FIG. 2: shows a schematic representation of the housing of a ball valve according to the state of the art,

FIG. 3: shows a schematic sectional representation of an exemplary embodiment of a ball valve according to the invention,

FIG. 4A: shows a perspective representation of an exemplary embodiment of a housing of the ball valve according to the invention,

FIG. 4B: shows a schematic representation of an exemplary embodiment of a valve stem of the ball valve according to the invention,

FIG. 4C: shows a detail section of a sectional representation of an exemplary embodiment of the ball valve according to the invention,

FIG. 5: shows a further schematic sectional representation of an exemplary embodiment of a ball valve according to the invention,

FIGS. 6A-6C: show schematic sectional representations of three exemplary embodiments of a ball valve according to the invention, each having different fastening means for fastening the valve ball sealing seat elements, and

FIGS. 7A-7B: show two schematic representations of an exemplary embodiment of a valve stem and of an actuator coupling element of the ball valve according to the invention.

### DESCRIPTION OF AN EMBODIMENT

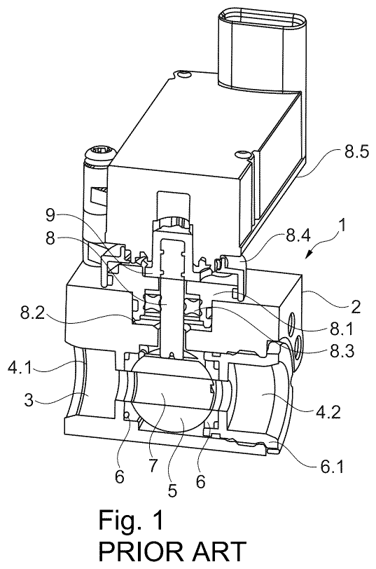

FIG. 1 shows a schematic sectional representation of an example of a ball valve 1 according to the state of the art. The ball valve 1 comprises a housing 2 with a fluid passage 3 which connects an inlet 4.1 to an outlet 4.2. In the fluid passage 3, a valve ball 5 is enclosed from two sides between valve ball sealing seat elements 6. The valve ball 5 has a through-hole 7 which, in the shown positioning of the valve ball 5, enables a flow through the fluid passage 3. Furthermore, the ball valve 1 comprises a cylindrical valve stem 8 which is coupled to the valve ball 5 for transmitting torque and which is received in a housing opening 8.2 of the housing 2, supported by a guide disc 8.1, and is sealed on the valve stem circumference by a sealing ring 8.3. The valve stem 8, which serves as a drive shaft, is coupled with its upper end to an actuator 8.5. The guide disc 8.1 has a stop mechanism 9 which serves to limit the rotation of the valve stem 8. The stop mechanism 9 is located on an end face of the guide disc 8.1 outside the housing 2 and covered by an intermediate element 8.4. A seal for sealing against the intermediate element 8.4 is arranged on the radial circumference of the guide disc 8.1. A further seal is located between the guide disc 8.1 and the housing opening 8.2 of the housing 2. The valve ball sealing seat elements 6 are fixed in the fluid passage 3 with a valve ball sealing seat element screw lock 6.1.

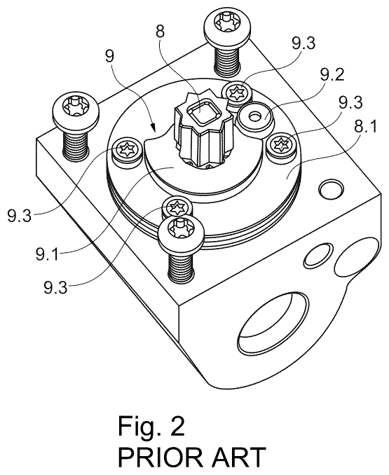

FIG. 2 shows a schematic representation of the housing 2 of a ball valve 1 according to the state of the art. The representation shows the housing 2 of FIG. 1 with a view to the stop mechanism 9 on the guide disc 8.1. The stop mechanism 9 comprises a stop disc 9.1 which is coupled to the valve stem 8 in a rotationally fixed manner and a cylindrical stop element 9.2 which is fastened to the guide disc 8.1. The stop disc 9.1 has a notched region which interacts with the stop element 9.2 such that a rotation of the valve stem 8 is limited. Four screws 9.3 which are screwed into the housing 2 are provided for fastening the guide disc 8.1.

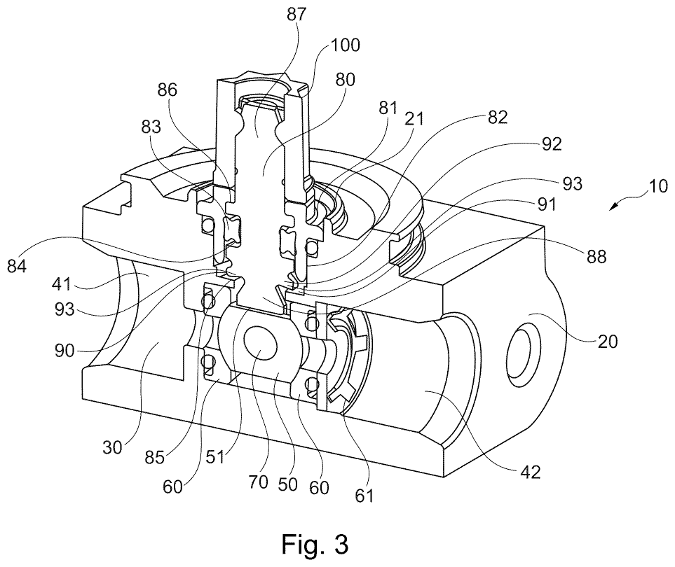

FIG. 3 shows a schematic sectional representation of an exemplary embodiment of a ball valve 10 according to the invention. According to the concept of the invention, the ball valve 10 has a housing 20 with a fluid passage 30 which connects an inlet 41 to an outlet 42. The inlet 41 and the outlet 42 represent fluid ports which can also be interchanged with respect to the fluid flow direction. In the fluid passage 30, a valve ball 50 is enclosed from two sides between valve ball sealing seat elements 60. Within the fluid passage 30, the valve ball sealing seat elements 60 are locked by a self-locking ring 61 pressed in from the outlet side. The valve ball 50 has a through-hole 70 which, in the shown representation, is in a blocking position so that no flow through the fluid passage 30 is possible. For torque transmission, the valve ball 50 is coupled to a valve stem 80. The valve stem 80 serves as a drive shaft in order to move the valve ball 50 by rotation from the blocking position into an open position. A sliding sleeve 81 is provided for mounting the valve stem 80. The sliding sleeve 81 is located in a housing opening 82 of the housing 20. For fastening the sliding sleeve 81, a collar 21 extending in the axial direction is formed on the housing opening 82 and is bent over towards the inside of the housing opening 82 by crimping. By crimping the collar 21, the material of the collar 21 is pressed against a shoulder of the sliding sleeve 81 so that the sliding sleeve 81 accommodated in the housing opening 82 is fixed. The valve stem 80 is sealed with respect to the sliding sleeve 81 by a sealing ring 83, wherein the sealing ring 83 is received in a groove 84 formed circumferentially on the valve stem 80.

The sliding sleeve 81 is formed as a wrap element which receives a valve stem shoulder 86 formed on the valve stem 80 so that the valve stem shoulder 86 rests against an axial inner surface of the sliding sleeve 81. Since the sliding sleeve 81 as a wrap element accommodates a valve stem shoulder 86 formed on the circumference of the valve stem 80, an axial limitation and mounting of the valve stem 80 is ensured.

In order to limit a rotational movement of the valve stem 80, a mechanical rotation stop 90 is formed in the interior of the housing 20. The mechanical rotation stop 90 has a stop geometry which is located on a shoulder 85 in the housing opening 82 formed as a stepped bore. The stop geometry is formed on the shoulder 85 of the housing opening 82 in the form of two separate annular cut-outs 91, wherein the end of the valve stem 80 facing the valve ball 50 is formed as an axially offset lower flat pin 88 with two lugs 93 which are radially opposite one another on a shoulder 92 and which are each in engagement with one of the separate annular cut-outs 91.

The end of the valve stem 80 formed as a lower flat pin 88 is used for torque transmission, wherein the flat pin end engages in a notch 51 formed on the valve ball 50.

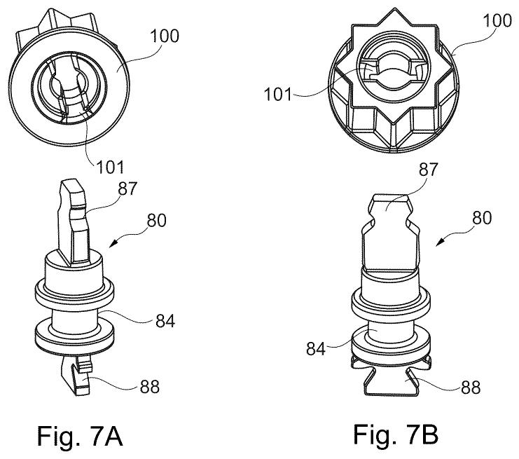

Reference numeral 100 designates an actuator coupling element which is latched to an upper flat pin 87 of the valve stem 80 and which is explained in more detail in FIGS. 7A and 7B.

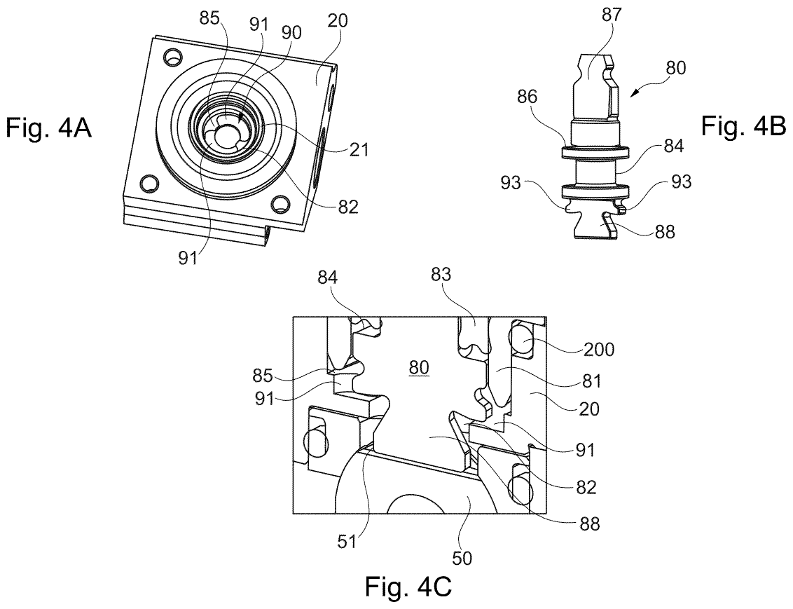

FIG. 4A shows a perspective representation of an exemplary embodiment of a housing 20 of the ball valve 10 according to the invention shown in FIG. 3. The view enables a view into the housing opening 82 formed as a stepped bore, with the annular cut-outs 91 of the stop geometry of the mechanical rotation stop 90 formed on the shoulder 85. At its upper edge, the housing opening 82 has the collar 21, which is bent over towards the opening centre in order to fix the sliding sleeve 81 (not shown) in the housing opening.

FIG. 4B shows a schematic representation of an exemplary embodiment of a valve stem 80 of the ball valve 10 according to the invention shown in FIG. 3. At its lower end, the valve stem 80 is formed as a stepped lower flat pin 88. In the axial direction, the lower flat pin 88 has a rectangular cross-section. On a shoulder of the lower flat pin 88, the lugs 93 are formed radially opposite one another. The lugs 93 are a component of the mechanical rotation stop 90 in that they engage in the annular cut-outs 91 shown in FIG. 4A. The interaction of the annular cut-outs 91 and the lugs 93 of the valve stem 80 is represented in the detailed view of FIG. 4C. The groove 84 for receiving the sealing ring 83 is located on the circumference of the valve stem 80 (see FIGS. 3 and 4C). The upper end of the valve stem 80 is also formed as an upper flat pin 87. The valve stem shoulder 86 serves for abutment against an axial inner surface of the sliding sleeve 81 (see FIG. 3). Between the upper flat pin 87 and the lower flat pin 88, the valve stem 80 has a circular cross-section in the axial direction.

FIG. 4C shows a detailed section of a sectional representation of an exemplary embodiment of the ball valve 10 according to the invention shown in FIG. 3. The valve stem 80 accommodated in the sliding sleeve 81 is represented in the housing opening 82 of the housing 20. The lower end of the valve stem 80 formed as a lower flat pin 88 engages with the notch 51 formed on the valve ball 50 for torque transmission. The lugs 93 formed on the valve stem 80 on the lower flat pin 88 each engage in an annular cut-out 91 formed on the shoulder 85. The flat pin shoulder on which the lugs 93 are formed is thus in engagement on both sides with a respective annular cut-out 91. The ends of the annular cut-outs 91 form stop positions for the lugs 93 so that rotation of the valve stem 80 is limited.

The valve stem 80 is sealed with respect to the sliding sleeve 81 by the sealing ring 83 arranged in the groove 84. The sealing ring 83 is characterised by an X-shaped cross-section. A further sealing ring 200 is located between the sliding sleeve 81 and the housing 20 in the housing opening 82. The sliding sleeve 81 consists of aluminium.

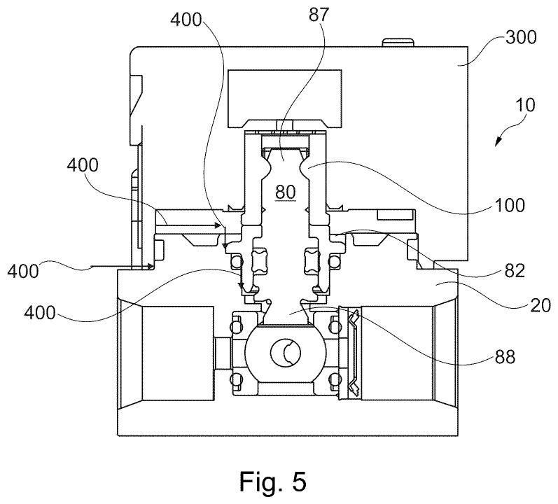

FIG. 5 shows a further schematic sectional representation of an exemplary embodiment of a ball valve 10 according to the invention. The shown exemplary embodiment of the ball valve 10 corresponds to the design of the ball valve 10 shown in FIG. 3, with the difference that an actuator 300 is additionally represented. The actuator 300 is connected to the actuator coupling element 100 for driving the valve stem 80. The arrows 400 represent a multi-stage sealing surface on the housing opening 82 of the housing 20 as an advantage of the invention.

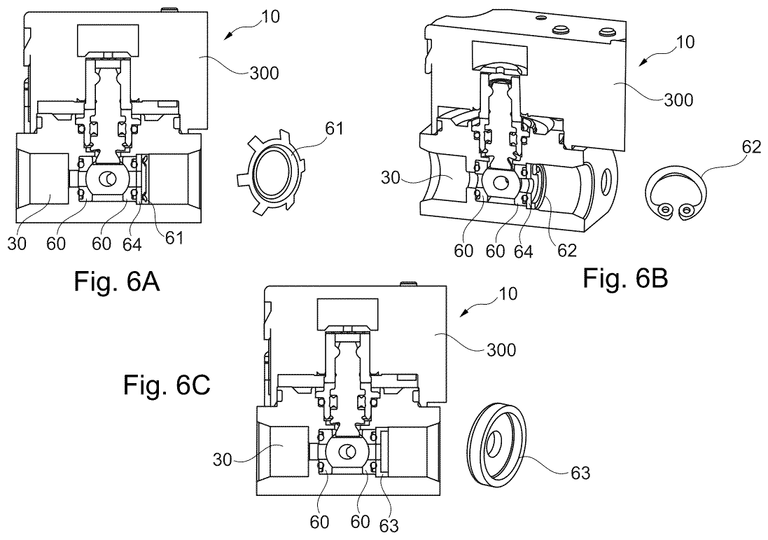

FIGS. 6A to 6C show schematic sectional representations of three exemplary embodiments of a ball valve 10 according to the invention, each having different fastening means for fastening the valve ball sealing seat elements 60 in the fluid passage 30. FIG. 6A shows the design of the ball valve 10 of FIG. 3, with the difference that an actuator 300 is additionally depicted. In order to fasten the valve ball sealing seat elements 60, the self-locking ring 61 is pressed into the fluid passage 30, wherein a ring disc 64 is arranged between the self-locking ring 61 and the valve ball sealing seat element 60. An enlarged representation of the self-locking ring 61 is depicted to the right of the sectional representation of the ball valve 10.

FIG. 6B shows the design of the ball valve 10 according to FIG. 6A, with the difference that a snap ring 62 is provided for fastening the valve ball sealing seat elements 60. In order to fasten the valve ball sealing seat elements 60, the snap ring 62 is pressed into the fluid passage 30, wherein a ring disc 64 is arranged between the snap ring 62 and the valve ball sealing seat element 60. A n enlarged representation of the snap ring 62 is depicted in FIG. 6B to the right of the sectional representation of the ball valve 10.

FIG. 6C shows the design of the ball valve 10 according to FIG. 6A, with the difference that a press-plug ring 63 is provided for fastening the valve ball sealing seat elements 60. In order to fasten the valve ball sealing seat elements 60, the press-plug ring 63 is pressed into the fluid passage 30, wherein no ring disc 64 is arranged between the press-plug ring 63 and the valve ball sealing seat element 60. A n enlarged representation of the press-plug ring 63 is depicted in FIG. 6C to the right of the sectional representation of the ball valve 10.

The use of a self-locking ring 61, a snap ring 62 or a press-plug ring 63 for locking the valve ball sealing seat elements 60 represents a further measure for reducing the complexity of the ball valve 10. Thus, a complicated thread production for the use of a valve ball sealing seat element screw lock 6.1 according to the design of a ball valve 1 shown in FIG. 1 is no longer necessary.

FIGS. 7A and 7B each show a schematic representation of an exemplary embodiment of a valve stem 80 and of an associated actuator coupling element 100 of the ball valve 10 according to the invention shown in FIG. 3. FIG. 7A shows the actuator coupling element 100 from an underside. The upper side of the actuator coupling element 100 is shown in FIG. 7B. The actuator coupling element 100 has an opening 101 in the form of a rectangular recess so that the actuator coupling element 100 can be plugged onto the upper flat pin of the valve stem 80. Furthermore, two latching lugs are formed within the opening 101 of the actuator coupling element 100, which engage in undercuts formed on the upper flat pin 87 so that the actuator coupling element 100 latches on the upper flat pin 87 when it is plugged onto the upper flat pin 87.

The lower end of the valve stem 80 forms the lower flat pin 88.

A serrated profile for coupling to an actuator 300 (not shown) is formed on the upper side of the actuator coupling element 100. The groove 84 serves to receive the sealing ring 83 which is not represented in FIGS. 7A and 7B.

### LIST OF REFERENCE NUMERALS

1 ball valve
2 housing
3 fluid passage
4.1 inlet
4.2 outlet
5 valve ball
6 valve ball sealing seat element
6.1 valve ball sealing seat element screw lock
7 through-hole
8 valve stem
8.1 guide disc
8.2 housing opening
8.3 sealing ring
8.4 intermediate element
8.5 actuator
9 stop mechanism
9.1 stop disc
9.2 stop element
9.3 screw
10 ball valve
20 housing
21 collar
30 fluid passage
41 inlet
42 outlet
50 valve ball
51 notch
60 valve ball sealing seat element
61 self-locking ring
62 snap ring
63 press-plug ring
64 ring disc
70 through-hole
80 valve stem
81 sliding sleeve
82 housing opening
83 sealing ring
84 groove
85 shoulder
86 valve stem shoulder
87 upper flat pin
88 lower flat pin
90 mechanical rotation stop
91 annular cut-out
92 shoulder
93 lug
100 actuator coupling element
101 opening
200 sealing ring
300 actuator
400 arrow

What is claimed is:

1. A ball valve comprising:
a housing with at least one fluid passage connecting at least one inlet to at least one outlet;
a valve ball, which has a through-hole, arranged between valve ball sealing seat elements in the at least one fluid passage;
a valve stem coupled to the valve ball for torque transmission, which, supported by a sliding sleeve, is received in a housing opening and sealed with a sealing ring on a circumference of the valve stem; and
a mechanical rotation stop which is formed for limiting a rotational movement of the valve stem in an interior of the housing.

2. The ball valve according to claim 1, wherein the mechanical rotation stop has a stop geometry formed in the housing opening in the interior of the housing which interacts with at least one lug formed on the circumference of the valve stem such that a stop of the at least one lug on the stop geometry limits the rotational movement of the valve stem.

3. The ball valve according to claim 2, wherein the stop geometry on a shoulder of the housing opening is formed as two separate annular cut-outs, wherein a first end of the valve stem facing the valve ball is formed as an axially offset lower flat pin which has on a shoulder two radially opposite ones of the at least one lug which are in each case in engagement with one of the separate annular cut-outs.

4. The ball valve according to claim 3, wherein the first end of the valve stem formed as the lower flat pin engages in a notch formed on the valve ball for torque transmission.

5. The ball valve according to claim 1, wherein the housing opening has a collar which is bent over towards an inside of the housing opening to fasten the sliding sleeve in the housing opening.

6. The ball valve according to claim 1, wherein the valve stem has, at one end facing away from the valve ball, an upper flat pin for coupling to a drive element of an actuator.

7. The ball valve according to claim 6, wherein the upper flat pin cooperates with an actuator coupling element for coupling to the drive element of the actuator, wherein the actuator coupling element has an opening in a form of a rectangular recess so that the actuator coupling element can be plugged onto the upper flat pin of the valve stem.

8. The ball valve according to claim 7, wherein the upper flat pin has an axial shoulder with an undercut on which the actuator coupling element engages on the upper flat pin.

9. The ball valve according to claim 8, wherein the upper flat pin and a lower flat pin are formed at axially opposite ends of the valve stem and each have a rectangular cross-section.

10. The ball valve according to claim 9, wherein the upper flat pin and the lower flat pin on a circumference thereof have a longitudinal side and a broad side, wherein a length of the longitudinal side is several times greater than a length of the broad side.

11. The ball valve according to claim 1, wherein the valve stem has a circumferentially formed groove in which the sealing ring is arranged for sealing with respect to the sliding sleeve.

12. The ball valve according to claim 1, wherein the sealing ring has an X-shaped cross-section.

13. The ball valve according to claim 1, wherein the valve stem has a valve stem shoulder formed on the circumference, wherein the sliding sleeve is formed as a wrap element which accommodates the valve stem shoulder formed on the valve stem in itself so that the valve stem shoulder bears against an axial inner surface of the sliding sleeve.

14. The ball valve according to claim 1, wherein arrangement of the valve ball sealing seat elements encompassing the valve ball is fixed in the at least one fluid passage by a self-locking ring, a snap ring or a press-plug ring.

15. A use of the ball valve according to claim 1 in a refrigerant circuit of an air-conditioning system.
